(19) United States
(12) Patent Application Publication
(10) Pub. No.: US 2016/0068013 A1
(43) Pub. Date: Mar. 10, 2016

(54) Stencil Kit System

(71) Applicant: Maria Munoz, Lancaster, CA (US)

(72) Inventor: Maria Munoz, Lancaster, CA (US)

(21) Appl. No.: 14/482,710

(22) Filed: Sep. 10, 2014

(51) Int. Cl. B44D 2/00

(52) U.S. Cl. CPC B44D 2/007

(57) ABSTRACT

A stencil kit system facilitates the application of indicia to a substrate, such as a lawn surface. The system includes a stencil. The stencil includes a side wall having a top edge, a bottom edge, an interior surface and an exterior surface. Each of the top edge and the bottom edge provides access to an interior space of the stencil extending between opposite sides of the interior surface. The interior space of the stencil is shaped to define indicia. A top wall is coupled to and extends outwardly from the top edge of the side wall.

### BACKGROUND OF THE DISCLOSURE

### Field of the Disclosure

The disclosure relates to stencil systems and more particularly pertains to a new stencil system for facilitating the application of indicia to a substrate, such as a lawn surface.

### SUMMARY OF THE DISCLOSURE

An embodiment of the disclosure meets the needs presented above by generally comprising a stencil. The stencil includes a side wall having a top edge, a bottom edge, an interior surface and an exterior surface. Each of the top edge and the bottom edge provides access to an interior space of the stencil extending between opposite sides of the interior surface. The interior space of the stencil is shaped to define indicia. A top wall is coupled to and extends outwardly from the top edge of the side wall.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a top front side perspective view of a stencil of a stencil kit system according to an embodiment of the disclosure.

FIG. 2 is a bottom view of a stencil of an embodiment of the disclosure.

FIG. 3 is a top view of a plurality of stencils of an embodiment of the disclosure.

FIG. 4 is a top view of a plurality of stencils of an alternative embodiment of the disclosure.

FIG. 5 is a top view of an embodiment of the disclosure in use.

FIG. 6 is an in-use view of an embodiment of the disclosure showing indicia applied to a substrate.

### DESCRIPTION OF THE PREFERRED EMBODIMENT

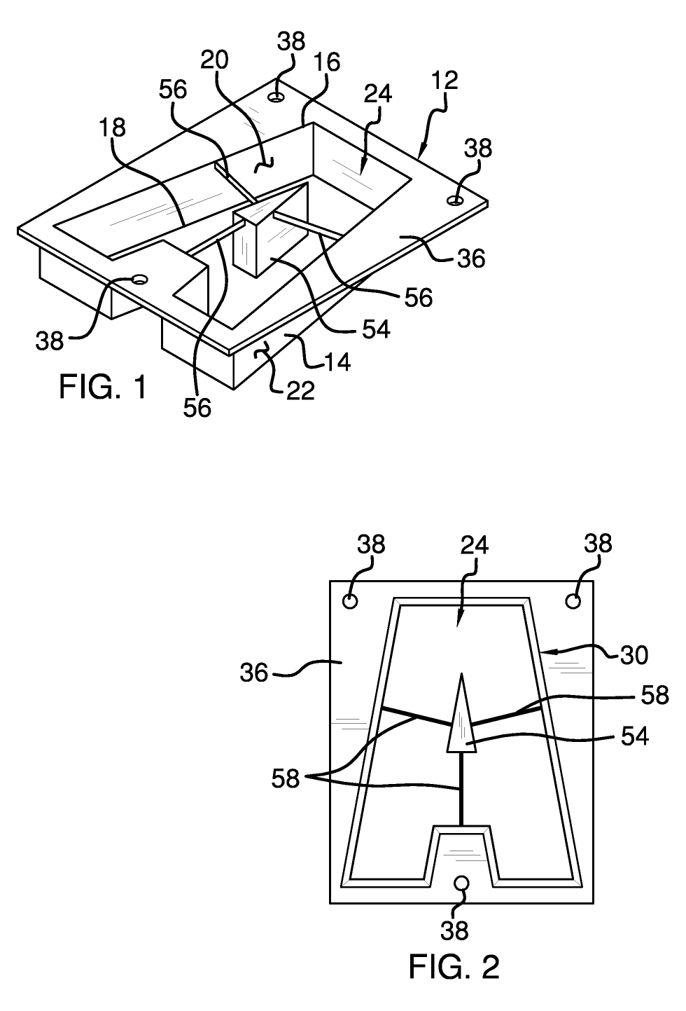

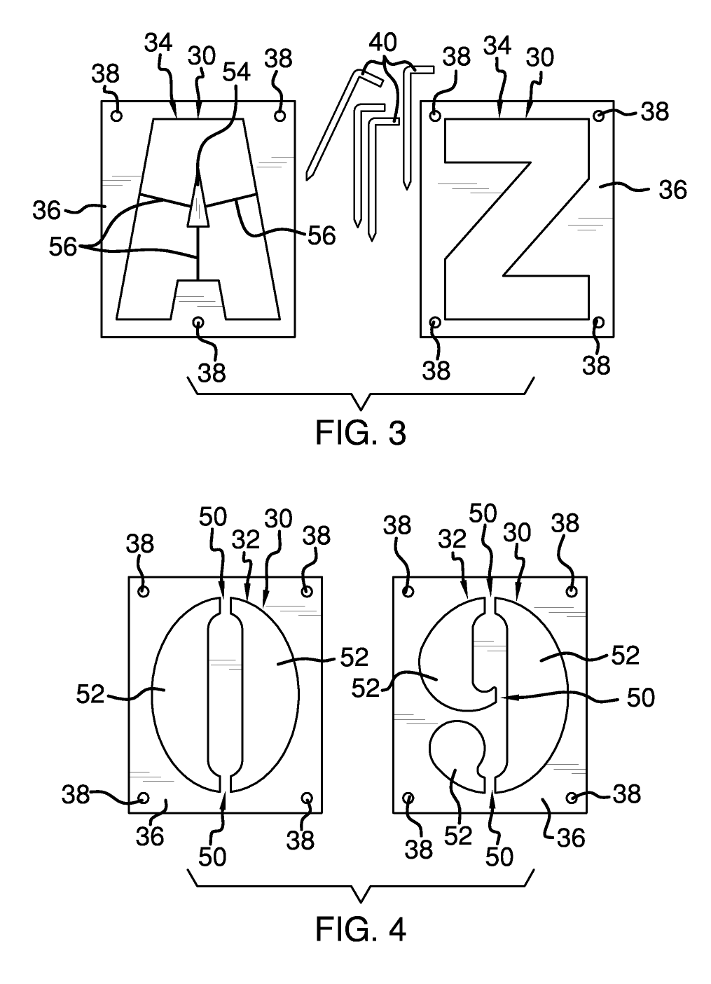

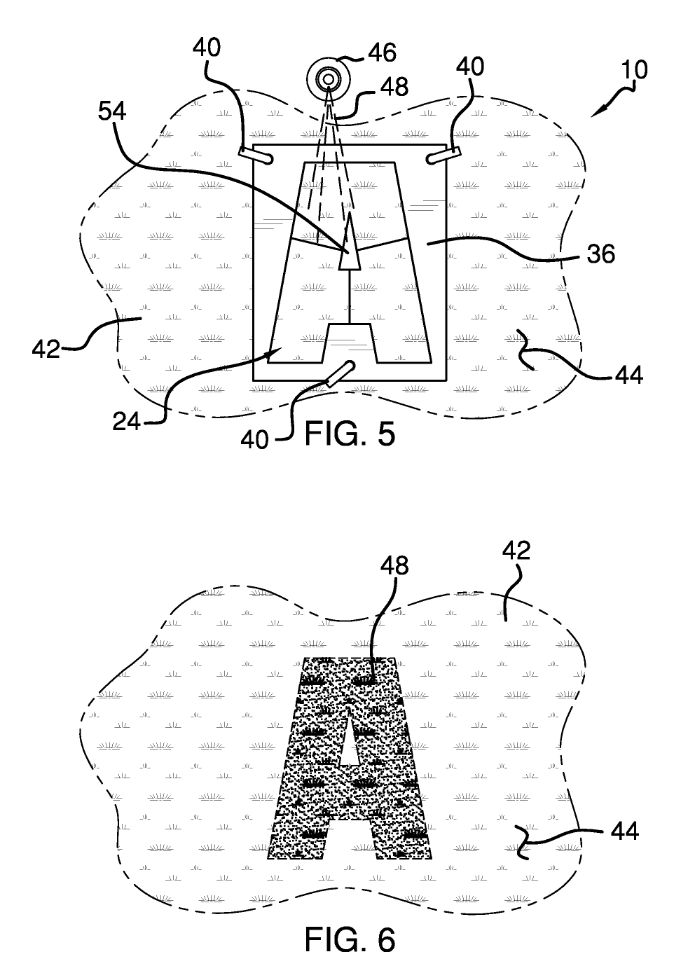

With reference now to the drawings, and in particular to FIGS. 1 through 6 thereof, a new stencil system embodying the principles and concepts of an embodiment of the disclosure and generally designated by the reference numeral 10 will be described.

As best illustrated in FIGS. 1 through 6, the stencil kit system 10 generally comprises a stencil 12. The stencil 12 includes a side wall 14 having a top edge 16, a bottom edge 18, an interior surface 20 and an exterior surface 22. Each of the top edge 16 and the bottom edge 18 provides access to an interior space 24 of the stencil 12 extending between opposite sides of the interior surface 20. The interior space 24 of the stencil 12 is shaped to define indicia 30, such as numerals 32, letters 34, themes or the like.

A top wall 36 is coupled to and extends outwardly from the top edge 16 of the side wall 14. The top wall 36 has a plurality of apertures 38 extending therethrough. The top wall 36 is coextensive with the top edge 16 of the side wall 14. The top wall 36 and the side wall 14 are comprised of a rigid material, such as plastic or the like.

A plurality of anchors 40 is provided. Each of the anchors 40 is insertable into an associated one of the apertures 38 wherein the anchors 40 are configured for releasably securing the stencil 12 to a substrate 42. Each of the anchors 40 may comprise a conventional stake for being inserted into a ground surface 44.

A container 46 is provided. A composition 48 is positioned within an interior of the container 46 wherein the composition 48 is configured for being sprayed into the interior space 24 of the stencil 12 onto the substrate 42 positioned below the interior space 24. The composition 48 may comprise spray paint that is biodegradable and can safely be used on lawns. The container 46 may incorporate a conventional dispenser allowing a user to spray the composition 48 when the container 46 is in an inverted position. Multiple containers 46 may be provided with distinct and varying colors of the composition 48 to permit application of various color schemes and designs onto the substrate 42.

The indicia 30 may have a plurality of breaks 50 therein defining a plurality of indicia sections 52. The top wall 36 is coupled to and extends between each of the indicia sections 52. Depending on the particular indicia 30 being formed, one or more blocks 54 may be positioned in the interior space 24 of the stencil 12. A plurality of spacers 56 is provided. Each of the spacers 56 is coupled to and extends between the interior surface 20 of the side wall 14 and each block 54 for providing space between each block 54 and the interior surface 20 of the side wall 14. Each of the spacers 56 may comprise an elongated rod 58.

In use, the stencil 12 is positioned on a freshly-cut lawn surface. The anchors 40 and the side wall 14 are both inserted downwardly into the ground surface 44 to secure the stencil 12 to the ground surface 44. The composition 48 is sprayed onto the ground surface 44 into the interior space 24 of the stencil 12 such that the indicia 30 of the stencil 12 is applied to the ground surface 44. The process can be repeated with various stencils 12 to apply numerous indicia 30 to the ground surface 44. The anchors 40 and the stencils 12 can then be removed from the ground surface 44.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A stencil kit system comprising:
a stencil, said stencil including
a side wall having a top edge, a bottom edge, an interior surface and an exterior surface, each of said top edge and said bottom edge providing access to an interior space of said stencil extending between opposite sides of said interior surface, said interior space of said stencil being shaped to define indicia; and
a top wall coupled to and extending outwardly from said top edge of said side wall wherein said bottom edge of said side wall defining said indicia is positioned in vertically spaced relationship to said top wall such that said bottom edge of said side wall is configured for resting on a substrate.

2. The system of claim 1, further comprising:
said top wall having a plurality of apertures extending therethrough; and
a plurality of anchors, each of said anchors being insertable into an associated one of said apertures wherein said anchors are configured for releasably securing said stencil to the substrate.

3. The system of claim 2, further comprising each of said anchors comprising stakes.

4. The system of claim 1, further comprising said top wall being coextensive with said top edge of said side wall.

5. The system of claim 1, further comprising said top wall and said side wall being comprised of a rigid material.

6. The system of claim 1, further comprising said indicia having a plurality of breaks therein defining a plurality of indicia sections, said top wall being coupled to and extending between each of said indicia sections.

7. The system of claim 1, further comprising:
a block positioned in said interior space of said stencil; and
a plurality of spacers, each of said spacers being coupled to and extending between said interior surface of said side wall and said block for providing space between said block and said interior surface of said side wall.

8. The system of claim 7, further comprising each of said spacers comprising an elongated rod.

9. The system of claim 1, further comprising a container, a composition being positioned within an interior of said container wherein said composition is configured for being sprayed into an interior space of said stencil onto a substrate positioned below said stencil.

10. The system of claim 9, further comprising said composition being biodegradable.

11. The system of claim 9, further comprising wherein said composition comprises spray paint.

12. A stencil kit system comprising:
a stencil, said stencil including;
a side wall having a top edge, a bottom edge, an interior surface and an exterior surface, each of said top edge and said bottom edge providing access to an interior space of said stencil extending between opposite sides of said interior surface, said interior space of said stencil being shaped to define indicia; and
a top wall coupled to and extending outwardly from said top edge of said side wall wherein said bottom edge of said side wall defining said indicia is positioned in vertically spaced relationship to said top wall such that said bottom edge of said side wall is configured for resting on a substrate, said top wall having a plurality of apertures extending therethrough, said top wall being coextensive with said top edge of said side wall, said top wall and said side wall being comprised of a rigid material;
a plurality of anchors, each of said anchors being insertable into an associated one of said apertures wherein said anchors are configured for releasably securing said stencil to the substrate, each of said anchors comprising stakes; and
a container, a composition being positioned within an interior of said container wherein said composition is configured for being sprayed into said interior space of said stencil onto the substrate positioned below said interior space, said composition being biodegradable, said composition comprising spray paint.

13. The system of claim 12, further comprising said indicia having a plurality of breaks therein defining a plurality of indicia sections, said top wall being coupled to and extending between each of said indicia sections.

14. The system of claim 12, further comprising:
a block positioned in said interior space of said stencil; and
a plurality of spacers, each of said spacers being coupled to and extending between said interior surface of said side wall and said block for providing space between said block and said interior surface of said side wall, each of said spacers comprising an elongated rod.
